(19) United States
(12) Patent Application Publication
(10) Pub. No.: US 2005/0030615 A1
(43) Pub. Date: Feb. 10, 2005

(54) Measured array for slides

(76) Inventors: Jiming Mei, Ellicott City, MD (US); Dennis Xiang, Germantown, MD (US)

Correspondence Address: Law Offices of Royal W. Graig;Suite 153, 10 N. Calvert Street, Baltimore, MD, 21202, US

(21) Appl. No.: 10/635,364

(22) Filed: Aug. 6, 2003

(51) Int. Cl. G02B 21/34

(52) U.S. Cl. 359/397

(57) ABSTRACT

A holder for microarray slides made from plastic or other appropriate material. The holder consists of a base, three short walls, four tabs for securing the slide in place, a thumb-grip to facilitate gripping and moving the holder. The base displays a grid which allows a plurality of samples to be organized, tracked, and stained on the same slide.

### BACKGROUND OF THE INVENTION

1. Field of the Invention

The present invention relates to staining slides for biological analysis and, more particularly, to holders of microarray slides of the type used for hybridization and further analysis, and specifically a microarray slide holder with a grid for assisting transfer, spot biological samples and indicating locations of spots (arrays) on the microarray slide.

2. Description of the Background

Biological microanalysis frequently entails staining samples on a slide. The samples require staining because they typically lack color or internal structures, making them difficult to see. Dyes or stains are used to alleviate this problem.

Microarray is a popular and powerful technology utilized by biologists to study gene expression and function, as well as drug screening. Microarray involves preparation of samples such as DNA or protein, transfer samples from a source e.g. centrifuge tubes, microtitre plate and spotting onto a slide such as a microscope or microarray slide manually or with an arraying machine, hybridization of the samples, scanning of the results of the hybridization, and analysis of these results. The samples are first spotted and bonded onto the glass slide and then hybridized with labeled probes or antibodies. In a typical procedure, the hybridization buffer containing the probes or antibodies is placed on the surface of the spotted samples and both are then covered with a cover slide and placed in an incubator for several hours.

It is exceedingly difficult to accurately transfer the samples onto the slide in the form of small, distinct:micro spots, and to then stain each spot. Particularly, transfer samples from a microtitre plate. Microtitre plates commonly hold 96, 384 or 1,534 different DNA samples. The sample material is often clear and thus once it is dry it can be very difficult to know where a spot has already been placed and therefore exactly where the next spot should be placed on the target.

Hybridization is a sensitive procedure, requiring the buffer to contain a specific concentration of the probe or antibody. Only a small amount of the hybridization buffer can be used on one slide—usually between 10 and 100 μl. Thus, the hybridization buffer may not adequately contact all of the samples, or the probes or antibodies in the hybridization buffer may be too dilute to be effective. Therefore, a matrix viewed on the glass slide would allow the sample locations to be easily tracked, and allow buffer to be applied only in those places on the slide where the samples exist, increasing the effectiveness of the hybridization buffer and insuring each sample is exposed to a sufficient amount of the buffer.

Busy histology and cytology laboratories spotting and stain many slides during the day, sometimes as many as 1,000 slides-per hour. The spotting staining process has grown more complex owing to today's more advanced analyzers which typically employ customized in-house microarray DNA chips made, for example, of Micro-Electro-Mechanical Systems (MEMS) devices. These analyzers require hundreds of samples spotted on a single slide, and each sample must be stained. It is very difficult to stain an array of samples on a slide because the samples are often difficult to see, especially with a close-packed array of samples. It is therefore desired to overcome the problems associated with conventional spotting and staining techniques. Consequently, it would be greatly advantageous to provide a slide-holder with an indexed microarray to assist in spotting and staining samples on a slide.

One attempt to solve a similar problem is taught in U.S. Pat. No. 6,597,500 to Burke et al. Burke '500 teaches an adhesive label with a grid imprinted upon it for use with a microscopic slide. The adhesive grid is attached to the slide itself, and the grid is viewable through the glass slide. Unlike the present invention, the sticker becomes a permanent part of the slide. A different sticker is necessary for each slide to be used. In the present invention, any number of slides can be slid into or out of the slide holder.

Also of interest is U.S. Pat. No. 6,006,911 to Levy. Levy '911 teaches a holder for a specimen slide that is disposable. While there are many patents in existence that teach a slide holder, illustrating a wide variety of ways to secure a slide in a holder for viewing, none of these, including Levy '911, teach the microarray which is the hallmark of the present invention.

### SUMMARY OF THE INVENTION

Accordingly, it is an object of the present invention to provide a microarray slide holder, made of hardened plastic or another appropriate, durable material, with an indexed grid to assist in staining samples on a slide, and tabs located along the walls of the holder, said tabs used to hold the slide in place after it is slid into the holder.

It is yet another object to provide a microarray slide holder into which a slide can be slid into the holder via the long end of the holder. This embodiment of the slide holder includes two tabs located on the long wall of the holder and one tab on each of the short walls of the holder, said tabs used to hold the slide in place after it is slid into the holder.

It is yet another object to provide a microarray slide holder into which a slide can be slid into the holder via the short end of the holder. This embodiment of the slide holder has two tabs located on each long wall of the holder, said tabs used to hold the slide in place after it is slid into the holder.

It is yet another object to provide a grid that can be viewed through a slide that is inserted into the holder.

It is still another object to provide a grid of any matrix dimension required by the user.

It is still another object to provide a microarray slide holder with a plastic thumb-grip attached to one end to facilitate gripping and moving the holder.

### BRIEF DESCRIPTION OF THE DRAWINGS

Other objects, features, and advantages of the present invention will become more apparent from the following detailed description of the preferred embodiment and certain modifications thereof when taken together with the accompanying drawings in which:

FIG. 1 is a perspective view of one embodiment of the current invention showing the microarray slide holder and grid, and including four semi-circular tabs used to hold the slide in place. In this embodiment, the slide is slid into the holder via its short end.

FIG. 2 is a top view of the preferred embodiment of the slide holder including the four semi-circular tabs used to hold the slide in place.

FIG. 3 is a side view of the slide holder from the open end through which the slide is slid as it is inserted into the holder. Also shown are two of the semi-circular tabs used to hold the slide in place.

FIG. 4 is a top view of the slide holder including the grid and four semi-circular tabs used to hold the slide in place. In this embodiment the slide is slid into the holder via its long end.

FIG. 5 is a side view of the microarray slide holder from the closed end, illustrating the orientation of a slide as it is inserted into the slide holder via the long end of the holder. Two of the tabs, one on the short wall of the holder and one on the long wall of the holder, are also shown.

### DETAILED DESCRIPTION OF THE PREFERRED EMBODIMENTS

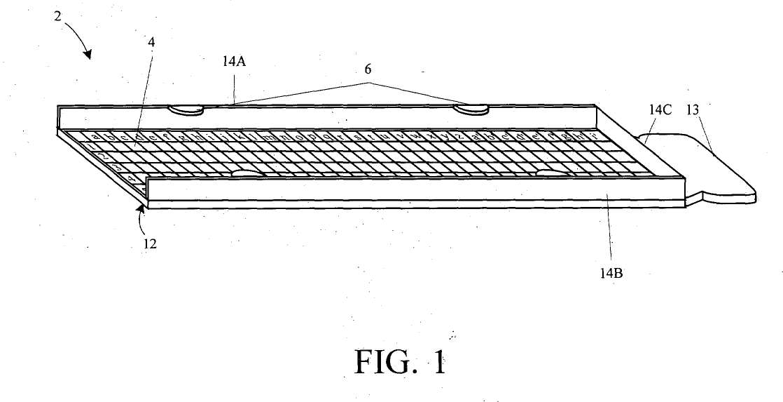

FIG. 1 is a perspective view of one embodiment of the invention which generally comprises a microarray slide holder 2 having an indexed grid 4 to assist in staining samples on the slide. Also included is an integral thumb-grip 13 used to improve one's grip on the holder. In this embodiment a slide is slid laterally into the slide holder 2 via its short end.

The holder is preferably molded of a rigid plastic material or other appropriate rigid material. The holder includes a thin base 12, slightly longer and wider than the slide it is designed to hold. The indexed grid 4 is inked or etched onto the side of the base 12 over which the slide is to be inserted. The grid 4 is a labeled matrix, for example, labeled across one side with letters and down the other side with numbers. In this manner, each square in the grid can be represented by a unique letter/number combination corresponding to the letter and number associated with that square. In addition, to provide a measured reference, the grid 4 may be labeled with ruled measurements (preferably metric mm).

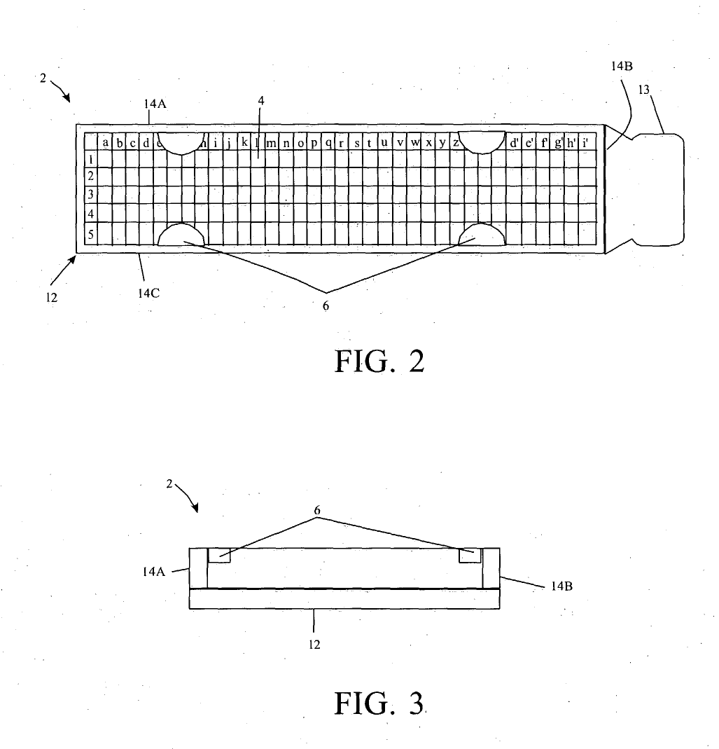

FIG. 2 is a top view of the slide holder 2 of FIG. 1, and FIG. 3 is a side view. The holder 2 also comprises three short walls 14a-14c and a plurality of semi-circular (or other appropriately shaped) tabs 6 attached to the top part of the walls 14a and 14b facing inward parallel to the base 12. The walls 14a-14c are of such a height that the slide can be slid into the holder 2 between the base 12 and the tabs 6, allowing the tabs 6 to hold the slide in place. The walls 14a-14c only rise on three sides of the base 12. The fourth side has no wall which allows access for the slide to be slid into the holder 2. Preferably, a thumb-grip 13 protrudes from second side 14c for easy holding of the slide holder 2. Raised ribs or serrations may be formed on the thumb-grip to increase friction.

In the preferred embodiment as illustrated in FIGS. 1-3, the slide is held in place by four tabs 6 attached to the walls of the holder. The tabs 6 are located two each on the long side walls 14a& 14b. In this embodiment the slide is slid into the holder via one short end of the holder where a wall is not present.

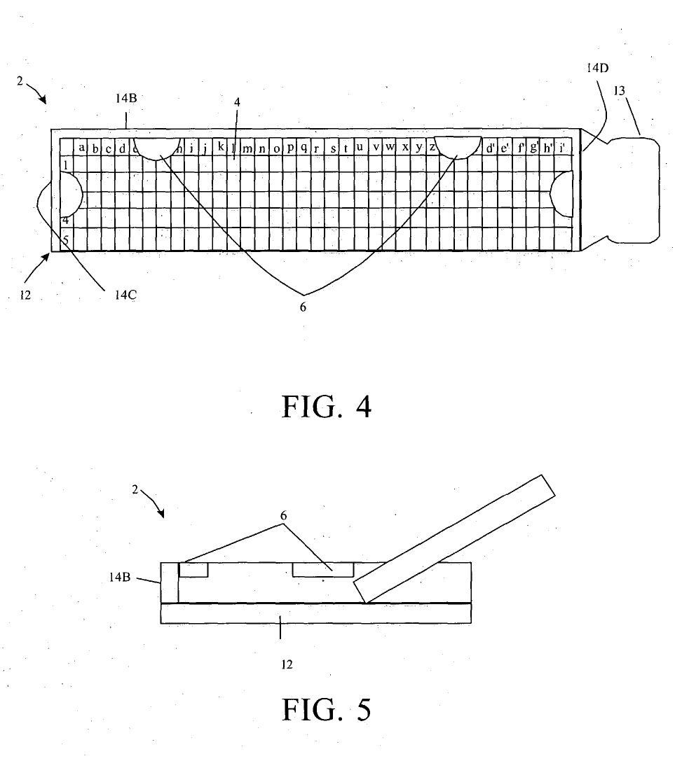

FIGS. 4 and 5 illustrate another embodiment in which the tabs 6 are located two along one long wall 14b and one each on each short wall 14c & 14d. In this embodiment the slide is slid into the holder via one long end of the holder 2 where a wall is not present. Thumb-grip 13 protrudes beneath the shorter side walls 14c.

In either embodiment, once the slide is slid onto the holder the grid is visible through the clear slide. The slide samples are fully indexed according to their location on the grid. In this manner, a large number of samples can be managed and tracked on the same slide without the danger of confusing or mistaking one sample for another.

Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims.

1. An apparatus for allowing a plurality of samples on a single slide to be organized and stained, comprising:
a base,
three walls,
four semi-circular tabs,; and
a labeled grid illustrated on the base.

2. The apparatus of claim 1, wherein the base comprises a thin, inflexible sheet of plastic, or other appropriate material, of a size slightly bigger in width and length than the slide to be used in conjunction with the base.

3. The apparatus of claim 1, wherein the walls comprise a continuous, raised boundary around three consecutive sides of the base, said walls creating a surface on the base the proper size for securing a slide within the area formed between the walls and the base.

4. The apparatus of claim 1, wherein the four semi-circular tabs are formed at the top of and perpendicular to the walls in such a manner as to create a space between the tabs and the base the proper width to secure a slide between the tabs and the base.

5. The apparatus of claim 1, wherein the grid is drawn on the base in the area defined by the base and the three walls, said grid consisting of a matrix and appropriate labels, said labels consisting of letters along one side of the array, and numbers along the other side of the array.

6. The apparatus of claim 1, further comprising a protruding thumb-grip for gripping the holder.

7. A method for using the slide holder comprising:
the step of inserting the slide into the holder via the side of the holder without a wall; and
the step of noting in which grid location within the microarray each sample is located.
